(19) United States
(12) Patent Application Publication
(10) Pub. No.: US 2026/0203023 A1
(43) Pub. Date: Jul. 16, 2026

(54) Effective In-Context Learning for DSL Generation

(71) Applicant: ServiceNow, Inc., Santa Clara, CA (US)

(72) Inventors: Qian Zhang, San Diego, CA (US); Shu-Wei Hsu, Mountain View, CA (US); Rodrigo Oliveira Fernandez, San Marcos, CA (US)

(21) Appl. No.: 19/020,047

(22) Filed: Jan. 14, 2025

(51) Int. Cl. G06F 8/30; G06F 9/54

(52) U.S. Cl. CPC G06F 8/30; G06F 9/54

(57) ABSTRACT

A method includes receiving a natural language query and determining that the natural language query is requesting generation of domain specific language (DSL) code. Based on determining that the natural language query is requesting generation of DSL code, the method includes retrieving a subset of documents from a search index including a set of documents based on the natural language query. Each document of the set of documents includes a respective portion of a DSL specification paired with a respective natural language context. The method includes generating a prompt based on the natural language query and the subset of documents. Using a large language model (LLM), the method includes generating the DSL code based on the prompt.

### TECHNICAL FIELD

This disclosure relates to code generation.

### BACKGROUND

Large language models (LLMs) are advanced neural network-based systems designed to generate natural language text in response to various inputs, including text, images, and speech. These models are trained on vast amounts of general-purpose data, such as web pages, books, and news articles. The extensive training enables LLMs to learn a wide range of linguistic patterns and acquire knowledge across different languages and domains. Despite their broad capabilities, LLMs are not inherently specialized in generating domain-specific language (DSL) code, which is a type of artificial language tailored for specific domains or purposes, characterized by its unique syntax, semantics, and constraints. Generating DSL code requires a high level of precision and accuracy, which poses a significant challenge for LLMs. This difficulty arises because DSL code is typically not included in the pre-training data set used to train LLMs. One option to address this challenge is continued pre-training (CPT) and fine-tuning on DSL code. However, this method is not scalable and can sometimes be infeasible since the DSL specifications may have continuously expanding features or updated/deprecated application programming interfaces (APIs). Moreover, for new DSL, the lack of real usage dataset may also limit the effectiveness of CPT and fine-tuning. These limitations highlight the need for more efficient and scalable solutions to enable LLMs to learn and generate accurate and precise DSL code across various domains.

### SUMMARY

One implementation of the disclosure provides a computer-implemented method of processing queries using a virtual agent with a plurality of LLM-based agents. The method includes receiving a natural language query and determining that the natural language query is requesting generation of domain specific (DSL) code. Based on determining that the natural language query is requesting generation of DSL code, the method includes retrieving a subset of documents from a search index including a set of documents based on the natural language query. The subset of documents may include the most relevant DSL specifications from indexed sources. Each document of the set of documents includes a respective portion of a DSL specification paired with a respective natural language context. The method includes generating a prompt based on the natural language query and the subset of documents. Using a large language model (LLM), the method includes generating the DSL code based on the prompt. This disclosure may provide the context and means to understand its runtime environments, enabling effective in-context learning of DSL knowledge per user prompt and context embedding.

Implementations of the disclosure may include one or more of the following optional features. In some implementations, the respective natural language context explains a relationship between the respective portion of the DSL specification and other respective portions of the DSL specification. The respective natural language context may describe application programming interface (API) steps of the respective portion of the DSL specification. In some examples, the DSL specification defines syntax, semantics, and structure for a plurality of APIs of the DSL. The DSL specification may include example DSL code and comments associated with the example DSL code.

In some implementations, for each document in the set of documents, the method includes generating a contextual prompt based on the DSL specification and the respective portion of the DSL specification, generating the respective natural language context based on the contextual prompt using the LLM, and storing the respective portion of the DSL specification paired with the respective natural language context in the search index. In these implementations, for each document in the set of documents, the method may further include generating a respective searchable embedding based on the respective portion of the DSL specification paired with the respective natural language context at the search index and storing the respective searchable embedding in the search index. Here, the method may further include, for each document of the set of documents, determining a relevancy score based on the natural language query and the respective searchable embedding. The method may further include, for each document in the subset of documents, determining that the relevancy score satisfies a relevancy threshold. Generating accurate DSL is one part of DSL based task, running the generated DSL requires environment/runtime variables to be resolved before the action can be performed. This disclosure may provide plugin modules for runtime resolver and diagnostic modules to ensure a successful execution of generated DSL.

In some examples, the examples further include determining that the DSL code satisfies a diagnostic threshold and deploying the DSL code based on determining that the DSL code satisfies the diagnostic threshold. The method may further include determining that the DSL code includes a dynamic parameter, retrieving a value for the dynamic parameter from a database, and modifying the DSL code based on the value for the dynamic parameter. In some implementations, the LLM is trained on training data that does not include any DSL code examples.

Another implementation of the disclosure provides a system that includes data processing hardware and memory hardware storing instructions that when executed on the data processing hardware causes the data processing hardware to perform operations. The operations include receiving a natural language query and determining that the natural language query is requesting generation of domain specific (DSL) code. Based on determining that the natural language query is requesting generation of DSL code, the operations include retrieving a subset of documents from a search index including a set of documents based on the natural language query. The subset of documents may include the most relevant DSL specifications from indexed sources. Each document of the set of documents includes a respective portion of a DSL specification paired with a respective natural language context. The operations include generating a prompt based on the natural language query and the subset of documents. Using a large language model (LLM), the operations include generating the DSL code based on the prompt.

Implementations of the disclosure may include one or more of the following optional features. In some implementations, the operations further include, for each document in the set of documents, generating a contextual prompt based on the DSL specification and the respective portion of the DSL specification, generating the respective natural language context based on the contextual prompt using the LLM, and storing the respective portion of the DSL specification paired with the respective natural language context in the search index. In these implementations, the operations may further include, for each document in the set of documents, generating a respective searchable embedding based on the respective portion of the DSL specification paired with the respective natural language context at the search index and storing the respective searchable embedding in the search index. Here, the operations may further include, for each document of the set of documents, determining a relevancy score based on the natural language query and the respective searchable embedding and, for each document in the subset of documents, determining that the relevancy score satisfies a relevancy threshold. In some examples, the operations further include determining that the DSL code satisfies a diagnostic threshold and deploying the DSL code based on determining that the DSL code satisfies the diagnostic threshold. The operations may further include determining that the DSL code includes a dynamic parameter, retrieving a value for the dynamic parameter from a database, and modifying the DSL code based on the value for the dynamic parameter.

Another implementation of the disclosure provides a computer-readable medium having instructions that, when executed by data processing hardware, causes the data processing hardware to perform operations. The operations include receiving a natural language query and determining that the natural language query is requesting generation of domain specific (DSL) code. Based on determining that the natural language query is requesting generation of DSL code, the operations include retrieving a subset of documents from a search index including a set of documents based on the natural language query. The subset of documents may include the most relevant DSL specifications from indexed sources. Each document of the set of documents includes a respective portion of a DSL specification paired with a respective natural language context. The operations include generating a prompt based on the natural language query and the subset of documents. Using a large language model (LLM), the operations include generating the DSL code based on the prompt.

The details of one or more implementations of the disclosure are set forth in the accompanying drawings and the description below. Other implementations, features, and advantages will be apparent from the description and drawings, and from the claims.

### DESCRIPTION OF DRAWINGS

FIG. 1 is a schematic view of an example system using in-context learning.

FIGS. 2A and 2B are illustrative views of example documents within an indexed source.

FIG. 3 is an illustrative view of an example DSL specification example.

FIG. 4 is a schematic view of an example process for generating the indexed source.

FIG. 5 is a flowchart of an example arrangement of operations for a computer-implemented method of generating DSL code.

FIG. 6 is a schematic view of an example computing device that may be used to implement the systems and methods described herein.

Like reference symbols in the various drawings indicate like elements.

### DETAILED DESCRIPTION

In recent years, the field of artificial intelligence (AI) has seen significant advancements, particularly in the development and application of large language models (LLMs). These models, which are trained on vast amounts of text data, have demonstrated remarkable capabilities in understanding and generating human language. However, the application of LLMs in specialized domains, such as domain-specific languages (DSLs), presents unique challenges because these specialized domains are often not included in training data for the LLMs. DSL is a specialized computer language tailored to a specific application domain that offers significant advantages in terms of expressiveness and efficiency for particular tasks.

One common approach to address this challenge is continued pre-training (CPT) and fine-tuning LLMs on DSL specification and code that was used in the original training dataset. However, the dynamic nature of many domains necessitates frequent updates and modifications to the DSLs, posing a challenge for maintaining and fine-tuning LLMs trained on these languages. Also, lack of real usage data for newly created DSL also adds difficulties to provide high quality training datasets. Thus, these approaches need to retrain the LLMs frequently to reflect the latest changes, but retraining and data preparation pipeline can be time consuming and expensive. In short, fine-tuning LLMs on tens, hundreds, or even thousands of DSLs is not sustainable to manage. Therefore, a more efficient solution is needed for adaptable and up-to-date DSL code generation.

Accordingly, implementations herein are directed towards a code generator that receives a natural language query and determines that the natural language query is requesting to generate domain specific language (DSL) code. Based on the natural language query, the code generator retrieves most relevant documents from an indexed source including a set of DSL specifications. Each document of the set of documents includes a respective portion of a DSL specification and is paired with a respective natural language context and an overlap of relevant APIs. The code generator creates (i.e., generates) a prompt based on the natural language query and the dynamically retrieved subset of documents and then instructs an LLM to generate the DSL code based on the natural language query and DSL specification context.

The DSL specification defines how to write DSL code for a specific task in a domain, together with general context of how-to, must-do, and not-do instructions. The DSL specification has examples and comments of DSL code and explains the syntax, semantics, and structure of the DSL's APIs with tools. The tools are the ways that the DSL interacts with other programs or data sources. In short, the DSL specification sets the rules and guidelines for using the DSL correctly and effectively. Notably, the LLM is not trained on any DSL code examples. However, the LLM still generates DSL code from a natural language query by finding the subset of documents from the DSL specification and examples that are relevant to the intent of the natural language query. The subset of documents enables the LLM to learn the DSL syntax and language rules according to the dynamically built context. Thus, the LLM is able to generate accurate DSL code without ever having to train or fine-tune on DSL code examples which is a computationally expensive and time-consuming process.

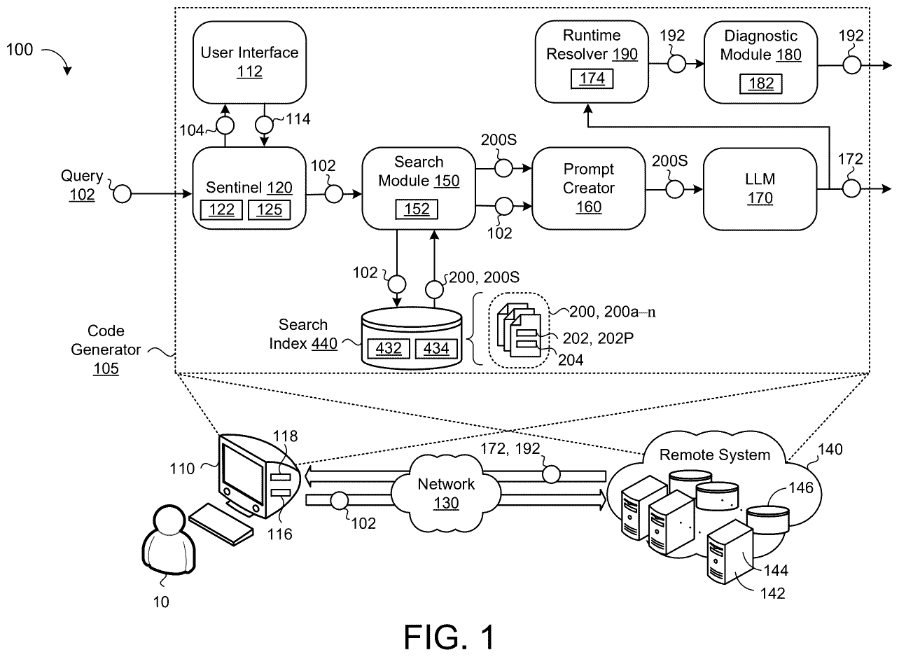

Referring to FIG. 1, in some implementations, a system 100 includes a remote system 140 in communication with one or more user device 110 each associated with a respective user 10 via a network 130, such as the Internet, a local area network (LAN), a wide area network (WAN), a cellular network, or a wireless network. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). The remote system 140 is configured to communicate with the user device 110 via the network 130. The user device 110 may correspond to any computing device, such as a desktop workstation, a laptop workstation, or a mobile device (i.e., a smart phone). Each user device 110 includes computing resources 116 (e.g., data processing hardware) and/or storage resources 118 (e.g., memory hardware).

The remote system 140 and/or the user device 110 may execute a code generator 105. The code generator 105 is configured to generate domain-specific language (DSL) code 172 from natural language queries 102 received from the user 10. DSL code 172 is a type of code that is tailored to a specific application domain, such as web development, data analysis, or machine learning. Moreover, DSL code 172 has a syntax and semantics that are configured to express the concepts and operations of the application domain in a concise and intuitive way. As such, the DSL code 172 may not be determined from having knowledge for general-purpose code because of the unique syntax and semantics particular to the DSL. For example, the DSL code 172 may use keywords, symbols, or structures that are specific to the application domain, such as HTML tags for web development, SQL commands for data analysis, or TensorFlow operations for machine learning. In some instances, the DSL code 172 abstracts away some of the low-level details or complexities of the underlying implementation or platform, such as memory management, data types, or libraries.

The code generator 105 includes a sentinel (i.e., query processor) 120 that receives a natural language query 102 from the user. The natural language query 102 is a text or speech input that expresses an intent or goal of the user 10 in natural language, such as “create a web page with a title and a table.” The sentinel 120 is configured to determine whether the natural language query 102 is requesting generation of DSL code 172. That is, the sentinel 120 determines whether the natural language query 102 is requesting generation of DSL code 172 or generation of different code, such as general-purpose code, or requesting a response that is not related to code generation at all. In some configurations, the sentinel 120 includes a large language model (LLM) 125 that processes the natural language query 102. More specifically, the LLM 125 of the sentinel 120 may use natural language understanding (NLU) to analyze the syntax and semantics of the natural language query 102 and to extract relevant information from the natural language query 102. The relevant information may include the domain, the task, and the parameters of the natural language query 102. For example, the relevant information may include that the domain is web development, the task is creating a web page, and the parameters are a title and a table.

In some examples, the sentinel 120 determines a confidence score 122 for the natural language query 102 based on the analysis of the natural language query 102 indicating a likelihood that the natural language query 102 is requesting DSL code 172. The confidence score 122 is a numerical value between 0 and 1, where 0 indicates the lowest likelihood and 1 indicates the greatest likelihood. The sentinel 120 may use various criteria to determine the confidence score 122, such as the presence of keywords, the similarity to previous queries, or the context of the user session. The sentinel 120 may also use a threshold value to determine whether the natural language query 102 is requesting generation of the DSL code 172 or not. For example, the sentinel 120 determines that the natural language query 102 with a confidence score 122 greater than or equal to 0.8 (e.g., threshold value) as requesting generation of the DSL code 172, otherwise determine that the natural language query 102 is not requesting generation of DSL code 172.

In some implementations, the sentinel 120 may provide assistance to the user 10 when the natural language query 102 does not clearly specify that the user 10 wants to generate DSL code 172. For example, the natural language query 102 may be ambiguous, incomplete, or irrelevant to the DSL code 172. In such cases, the sentinel 120 may infer the intent of the user 10 from the natural language query 102 and other contextual information, such as the user's profile, preferences, history, or domain knowledge. Based on the inferred intent, the sentinel 120 may generate one or more alternative natural language queries 104 that are more likely to request generation of DSL code 172. The sentinel 120 may display the alternative natural language queries 104 to the user 10 via a user interface 112, which may execute on the user device 110. The user interface 112 may allow the user 10 to view, compare, modify, or select one of the alternative natural language queries 104. The user 10 may provide a user input indication 114, such as a click, a tap, a voice command, or a gesture, to select one of the alternative natural language queries 104. The sentinel 120 may then send the selected alternative natural language query 104 as the natural language query 102 and proceed to generate the corresponding DSL code 172.

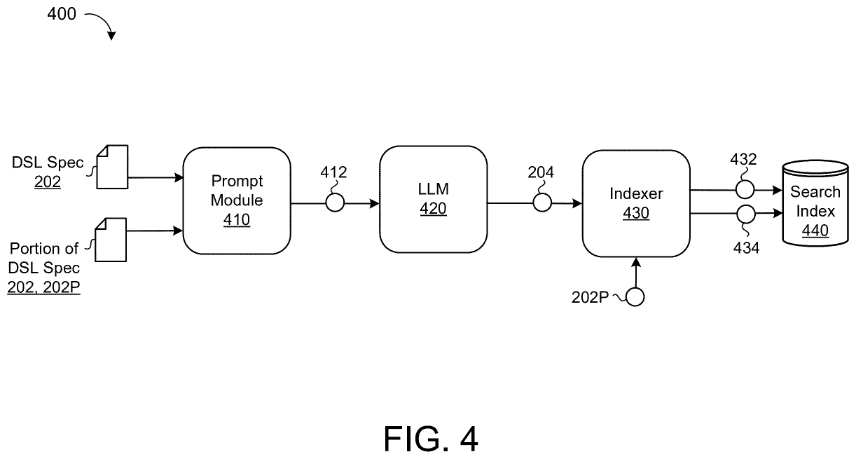

When the sentinel 120 determines that the user 10 is requesting generation of DSL code 172, the sentinel 120 sends the natural language query 102 to a search module 150. The search module 150 is configured to access a search index 440 that stores a set of documents 200. Generation of the search index 440 is described in greater detail with respect to FIG. 4. Each document 200 in the set of documents 200 includes a portion of a DSL specification 202, 202P paired with a respective natural language context 204. The DSL specification 202 is a formal description of the syntax and semantics of a DSL, which defines the rules and meanings of the DSL. In some instances, the DSL is associated with a plurality of APIs whereby the DSL specification 202 defines syntax, semantics, and structure for the plurality of APIs of the DSL. The DSL specification 202 may include elements such as keywords, operators, data types, expressions, statements, functions, and libraries that constitute the DSL code 172. In short, the DSL specification 202 serves as guidance or instructions for generating DSL code 172. However, the length of the DSL specification 202 may exceed the input token limit of a large language model (LLM) 170. The LLM 170 may be the same, or different, than the LLM 125 of the sentinel 120. Thus, the DSL specification 202 may be split into one or more portions of the DSL specification 202 each corresponding to one of the documents 200.

The natural language context 204 explains a relationship between the respective portion of the DSL specification 202P and other respective portions of the DSL specification 202P. Stated differently, the natural language context 204 provides additional information that clarifies the meaning and relevance of the respective portion of the DSL specification 202P in relation to the domain or problem that the DSL specification 202 addresses. Additionally or alternatively, the respective natural language context 204 may describe API steps of the respective portion of the DSL specification 202P. That is, the natural language context 204 may, in plain English, describe the API steps included in the respective portion of the DSL specification 202P.

Since the difference portions of the DSL specification 202P are spread across the set of documents 200 each portion of the DSL specification 202P, when considered alone, may not convey the full context or rationale of how the respective portion of the DSL specification 202P relates to other portions of the DSL specification 202P. Therefore, the natural language context 204 supplements the documents 200 with natural language descriptions or examples that explain how the DSL specification 202 works, why it is useful, and how it can be applied in the domain or problem. Thus, the natural language context 204 explains the relationship between the portions of the DSL specification 202P despite being separated across the set of documents 200. Put another way, the natural language context 204 may be a textual description or example of how the DSL specification 202 may be used or applied in the domain or problem. Accordingly, the natural language context 204 allows the search module 150 to better understand and interpret the natural language query 102 and to retrieve the most relevant portions of the DSL specifications that relate to the natural language query 102.

The natural language context 204 may include keywords, phrases, sentences, or paragraphs that illustrate the meaning, purpose, or functionality of the DSL specification 202 or the DSL code 172. For example, the natural language context 204 may explain the logic, input, output, or parameters of the DSL code 172, or provide a use case, scenario, or comparison with other languages or methods. The natural language context 204 helps the search module 150 to match the natural language query 102 with the relevant portions of the DSL specification 202P.

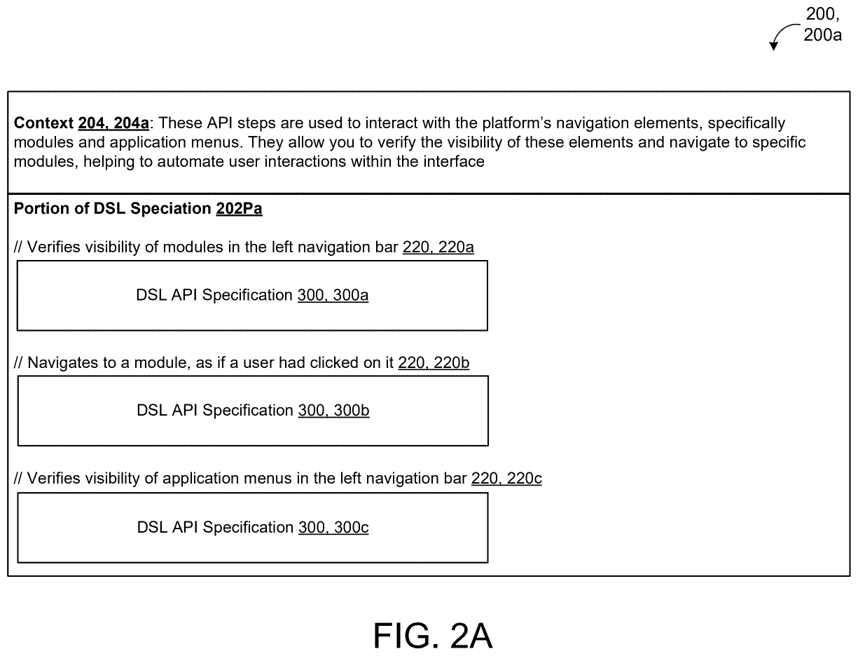

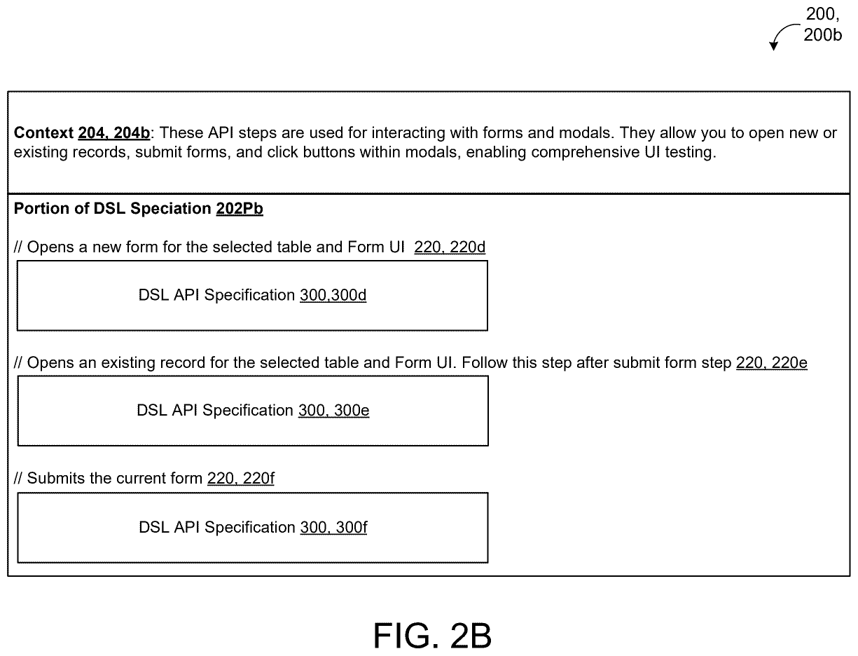

FIG. 2A illustrates a first example document 200, 200a. The first example document 200a includes a first portion of the DSL specification 202P, 202Pa paired with a first respective natural language context 204, 204a. The natural language context 204a provides additional information and explanation about the purpose and meaning of the first portion of the DSL specification 202Pa in plain English. The first portion of the DSL specification 202Pa includes three example DSL code snippets 300, 300a-c each associated with a corresponding comment 220, 220a-c. Each DSL code snippet 300 may correspond to a particular DSL API specification. Moreover, each example DSL code snippet 300 may include one or more lines of code whereby each line of code is associated with a comment 220. Each comment 220 includes non-executable code that explains or contextualizes the associated example DSL code snippet 300.

The comments 220 may provide the logic and intention behind the example DSL code snippets 300, or to provide additional details or examples that are not captured by the DSL syntax of the example DSL code snippets 300. For instance, the first comment 220a explains that the first example DSL code snippet 300a “verifies visibility of modules in the left navigation bar,” meaning that it checks whether the modules, which are the main categories of functionality within the software platform, are displayed on the left side of the user interface. The second comment 220b explains that the second example DSL code snippet 300b “navigates to a module, as if a user had clicked on it,” meaning that it simulates a user action of selecting a module from the left navigation bar and opening its corresponding page or view. The third comment 220c explains that the third example DSL code snippet 300c “verifies visibility of application menus in the left navigation bar,” meaning that it checks whether the application menus, which are the subcategories of functionality within each module, are displayed on the left side of the user interface when a module is selected. The first context 204a explains that the first portion of the DSL specification 202Pa includes API steps used to interact with the platform's navigation elements, specifically modules and application menus that allow you to verify the visibility of these elements and navigate to specific modules, helping to automate user interactions within the interface. That is, the first context 204a describes the API steps of the first portion of the DSL specification 202Pa and/or explains the relationship between the first portion of the DSL specification 202Pa and other respective portions of the DSL specification 202P.

FIG. 2B illustrates a second example document 200, 200b. The second example document 200b includes a second portion of the DSL specification 202P, 202Pb (e.g., different from the first portion of the DSL specification 202Pa (FIG. 2A)) paired with a second respective natural language context 204, 204b. The natural language context 204a provides additional information and explanation about the purpose and meaning of the second portion of the DSL specification 202Pb in plain English. The second portion of the DSL specification 202Pb includes three example DSL code snippets 300, 300d-f each associated with a corresponding comment 220, 220d-f. Each DSL code snippet 300 may correspond to a particular DSL API specification. Moreover, each example DSL code snippet 300 may include one or more lines of code whereby each line of code is associated with a comment 220. Each comment 220 includes non-executable code that explains or contextualizes the associated example DSL code snippet 300.

The comments 220 may provide the logic and intention behind the example DSL code snippets 300, or to provide additional details or examples that are not captured by the DSL syntax of the example DSL code snippets 300. For instance, the fourth comment 220d explains that the fourth example DSL code snippet 300b “opens a new form for the selected table and Form UI” meaning it opens a new form when executed. The fifth comment 220e explains that the fifth example DSL code snippet 300e “opens an existing record for the selected table and Form UI. Follow this step after submit form step,” meaning it opens an existing record for the selected table from the fourth example DSL code snippet 300b. The sixth comment 220f explains that the sixth example DSL code snippet 300f “submits the current form,” meaning that it submits the form after it has been filled out. The second context 204b explains that the second portion of the DSL specification 202Pb includes API steps for interacting with forms and modals that allow you to open new or existing records, submit forms, and click buttons within modals, enabling comprehensive UI testing. That is, the second context 204b describes the API steps of the second portion of the DSL specification 202Pb and/or explains the relationship between the second portion the DSL specification 202Pb and other respective portions of the DSL specification 202P.

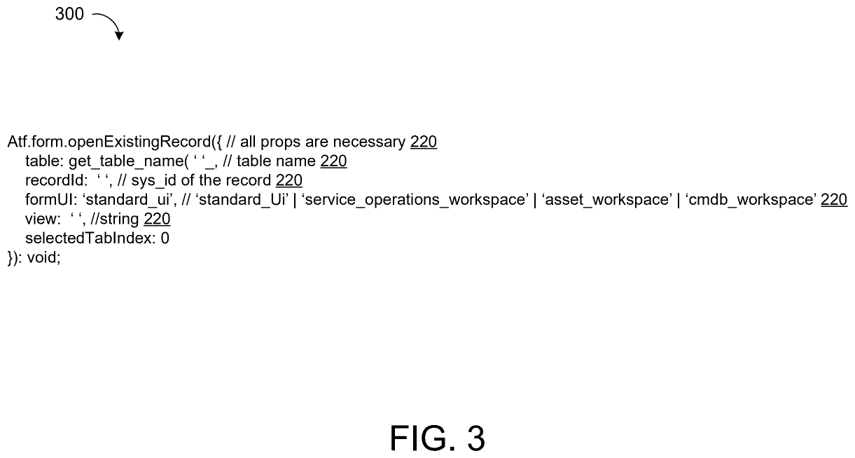

FIG. 3 illustrates an example DSL code snippet 300. In the example shown, the DSL code snippet 300 includes multiple lines of DSL code for performing the function of “opening an existing record.” In addition to, or in lieu of, the comment 220 associated with the example DSL code snippet 300, each line of DSL code may be associated with a comment 220. The comments 220 may provide the logic and intention behind the particular line of DSL code, or provide additional details or examples that are not captured by the particular line of DSL code.

Referring back to FIG. 1, the search module 150 is configured to retrieve a subset of documents 200, 200S based on the natural language query 102. Each document 200 in the subset of documents 200S retrieved by the search module 150 is related to the natural language query 102. The search module 150 may retrieve the subset of documents 200s by, for each document 200 of the set of documents 200, determining a relevancy score 152 based on the natural language query 102 and the respective natural language context 204 of the respective document 200. The relevancy score 152 indicates whether the respective document 200 includes information or guidance that is relevant to the DSL code 172 requested to be generated by the natural language query 102. The search module 150 determines the relevancy scores 152 by comparing the natural language query 102 to the respective natural language context 204 which explains, in plain language, what the function of the respective portion of the DSL specification 202P is. In short, the subset of documents 200S represent the documents of DSL knowledge from the search index 440 that are most relevant to the natural language query 102. Thus, the subset of documents 200S provide sorted context based on semantic search results using the natural language query 102.

In some implementations, the search index 440 stores pairings 432 of the respective portion of the DSL specification 202P and the respective natural language context 204. As such, when the search module 150 determines a respective natural language context 204 is relevant to a natural language query 102, the search module 150 retrieves the paired document 200 to the subset of documents 200S. Moreover, the search index 440 may store the searchable embeddings 434 of the respective portion of the DSL specification 202P and the respective natural language context 204. Thus, the search module 150 may perform an embedded search on the search index 440 by comparing the natural language query 102 to the searchable embeddings 434.

To that end, the search module 150 may determine, for each document 200 of the set of documents 200, the relevancy score 152 based on the natural language query 102 and the respective searchable embedding 434. Moreover, the search module 150 may determine whether the relevancy score 152 satisfies a relevancy threshold. When the relevancy score 152 satisfies the relevancy threshold, the search module 150 adds the respective document 200 to the subset of documents 200S. Otherwise, the document 200 is not added to the subset of documents 200S.

As such, the subset of documents 200S provides the knowledge required to generate the DSL code 172 requested by the natural language query 102. For instance, the subset of documents 200S may provide the necessary information or guidance to generate the DSL code 172 based on the relevant portions of the DSL specification 202P. The subset of documents 200S may also include documents 200 that do not include DSL code 172, but that provide useful background, context, or explanation of the DSL or the domain or problem.

A prompt generator (i.e., prompt creator) 160 receives the natural language query 102 and the subset of documents 200 and generates a prompt 162. The prompt 162 is configured to elicit the DSL code 172 requested by the natural language query 102 from an LLM 170. The prompt generator 160 transforms the natural language query 102, the natural language context 204, and/or the subset of documents 200S into the prompt 162 which has a format that is suitable for the LLM 170 to process and generate the DSL code 172. The prompt generator 160 may use various techniques, such as natural language generation, text summarization, or template filling, to generate the prompt 162. The prompt 162 may include elements such as a reformulation or clarification of the natural language query 102, a selection or extraction of the relevant portions of the DSL specification 202P or natural language context 204 from the subset of documents 200S, a hint or suggestion of the DSL code 172 structure or syntax, or a request or instruction for the LLM 170 to generate the DSL code 172. The prompt 162 provides the LLM 170 with the necessary information and guidance to generate the DSL code 172 that satisfies the natural language query 102, while avoiding ambiguity, redundancy, or inconsistency.

The LLM 170 processes the prompt 162 to generate the DSL code 172. Notably, the LLM 170 is trained on training data that does not include any DSL code examples. Despite the lack of training or fine-tuning on any DSL training data of any kind, the LLM 170 is still able to generate DSL code 172 based on processing the prompt 162 which was generated based on the subset of documents 200S that includes guidance on generating the DSL code 172 for the natural language query 102. In short, the subset of documents 200S enables the prompt generator 160 to generate the prompt 162 that guides the LLM 170 to generate the DSL code 172 despite the LLM 170 having not been trained on the DSL code 172 at all. Thus, instead of fine-tuning the LLM 170 to learn how to generate DSL code 172, the code generator 105 only needs to generate the search index 440. Advantageously, the search module 150 retrieves only the relevant subset of documents 200S explaining the relevant information for generating DSL code 172 for the natural language query 102. In contrast, providing all of the documents 200 may provide all the necessary information for generating DSL code 172, but may overwhelm the LLM 170 or even exceed the input token limit of the LLM 170.

In some instances, the generated DSL code 172 includes a dynamic parameter 174. The dynamic parameter 174 is a variable or placeholder that may have different values depending on the context or situation. For example, the dynamic parameter 174 may include a table name, user identification (ID), a system ID, etc. The value of the dynamic parameter 174 may change due to various factors, such as user input, system configuration, data updates, etc. The LLM 170 may not be able to determine the correct value for the dynamic parameter 174 in advance or at the time of generating the DSL code 172, even if the LLM 170 has been trained with a large amount of data and examples. The dynamic parameter 174 allows the DSL code 172 to be more flexible and adaptable to different scenarios and requirements, without requiring the user to manually edit the DSL code 172 or the LLM 170 to re-generate the DSL code 172.

To that end, the runtime resolver 190 may determine whether the DSL code 172 includes the dynamic parameter 174. When the runtime resolver 190 determines that the DSL code 172 includes the dynamic parameter 174, the runtime resolver 190 retrieves a value for the dynamic parameter 174 from a database. The database may be stored on memory hardware 118 of the user device 110 and/or the memory hardware 146 of the remote system 140. The database may store information about the possible values and sources of the dynamic parameters, as well as the rules and conditions for selecting the appropriate value. For instance, the database may store a list of table names and their corresponding system IDs, and a rule that the table name should match the system ID of the user device 110. Thereafter, the runtime resolver 190 modifies the DSL code 172 based on the value for the dynamic parameter 174 to generate modified DSL code 192. The modified DSL code 172 reflects the current and accurate value of the dynamic parameter. For example, if the DSL code 172 includes a dynamic parameter 174 representing a table name, and the user device 110 has a system ID of 123, the runtime resolver 190 may replace the dynamic parameter 174 with the table name that has the system ID of ‘123’ in the database, such as ‘Table_123.’ The modified DSL code 192 may then execute a query or operation on ‘Table_123,’ instead of using a generic or incorrect table name. When the runtime resolver 190 determines that the DSL code 172 does not include any dynamic parameters 174, the runtime resolver 190 may output the DSL code 172 in lieu of the modified DSL code 192.

The diagnostic module 180 is configured to determine whether the DSL code 172 or the modified DSL code 192 has any errors. That is, the diagnostic module 180 may perform various checks and/or validations on the DSL code 172 or the modified DSL code 192 to ensure its syntactic and semantic correctness, compatibility, and functionality. The diagnostic module 180 may determine whether the modified DSL code 192 satisfies a diagnostic threshold 182 and deploy the modified DSL code 192 based on determining that the modified DSL code 192 satisfies the diagnostic threshold 182. For example, the diagnostic module 180 may verify that the modified DSL code 192 follows the grammar and syntax rules of the DSL, that the modified DSL code 192 does not include any undefined or invalid symbols or expressions, that the modified DSL code 192 matches the specifications and requirements, that the modified DSL code 192 does not cause any conflicts or errors when executed, etc. The diagnostic module 180 may use various techniques and tools to perform the checks and validations, such as parsers, compilers, interpreters, debuggers, simulators, etc. The diagnostic module 180 may report any errors detected in the modified DSL code 192 to the runtime resolver 190 or the user, and may suggest possible corrections or solutions. The diagnostic module 180 may also provide feedback and guidance to the LLM 170 to improve its performance and accuracy in generating the DSL code 172.

The code generator 105 may deploy the DSL code 172 generated by the LLM 170. The code generator 105 may deploy the DSL code 172 by executing, interpreting, compiling, or translating it into another language or format, depending on a target platform or environment. For example, the code generator 105 may execute the DSL code 172 directly on a virtual machine, interpret the DSL code 172 using a runtime engine, or compile the DSL code 172 into a binary executable. In some configurations, the code generator 105 deploys the DSL code 172 without using the diagnostic module 180 or the runtime resolver 190. Deploying the DSL code 172 may include executing the DSL code 172 or incorporating the DSL code 172 into an application. Here, the DSL code 172 may already be valid, consistent, and optimized for the target platform or environment, or the code generator 105 does not have access to or need for the diagnostic module 180 or the runtime resolver 190. In other configurations, the code generator 105 deploys the DSL code 172 after using the diagnostic module 180 and/or the runtime resolver 190. Here, the code generator 105 may deploy the modified DSL code 192 in addition to, or in lieu of, the DSL code 172.

FIG. 4 illustrates an example process 400 for generating the search index 440. The example process 400 may execute on the data processing hardware 116 of the user device 110 and/or the data processing hardware 144 of the remote system 140. The process 400 employs a prompt module, a LLM 420, an indexer 430, and the search index 440. The LLM 420 of the process 400 may be the same, or different, as the LLM 125 of the sentinel 120 and LLM 170 (FIG. 1). For each document 200 in the set of documents 200, the prompt module 410 receives the DSL specification 202 and the respective portion of the DSL specification 202P and generates a contextual prompt 412 based on the DSL specification and the respective portion of the DSL specification 202P. The prompt module 410 may generate the contextual prompt 412 further based on the comments 220 associated with the respective portion of the DSL specification 202P. The contextual prompt 412 may include the DSL specification 202, the respective portion of the DSL specification 202P, and a request for the LLM 420 to generate the respective natural language context 204. For example, the contextual prompt 412 may include the request of “Here is the portion of the DSL specification we want to situate within the whole DSL specification. Please give a short succinct context to situate this portion within the overall DSL specification for the purpose of improving search retrieval of the portion, and for better understanding of the usage for APIs included in the portion. Answer only with succinct context and nothing else.”

Accordingly, the LLM 420 may process the contextual prompt 412 to generate the respective natural language context 204 for the respective portion of the DSL specification 202P. The indexer 430 is configured to create and maintain the search index 440 thereby enabling efficient retrieval of the subset of documents 200S (FIG. 1) based on natural language queries 102. In particular, the indexer 430 pairs the respective portion of the DSL specification 202P with the respective natural language context 204 and stores a pairing 432 of the respective portion of the DSL specification 202P and the respective natural language context 204 in the search index 440. In some examples, for each document 200 in the set of documents 200, the indexer 430 generates a respective searchable embedding 434 based on the respective portion of the DSL specification 202P paired with the respective natural language context 203 and stores the respective searchable embedding 434 in the search index 440. Each searchable embedding 434 may be a numerical representation of the respective portion of the DSL specification 202P and/or the respective natural language context 204. The searchable embedding 434 may capture the essential features and content of the respective portion of the DSL specification 202P and/or the respective natural language context 204. The searchable embedding 434 may be stored in the search index 440 along with the pairing 432. The searchable embedding 434 may allow the search module 150 (FIG. 1) to perform similarity-based or semantic-based searches for the subset of documents 200S, by comparing the searchable embedding 434 with the natural language queries 102.

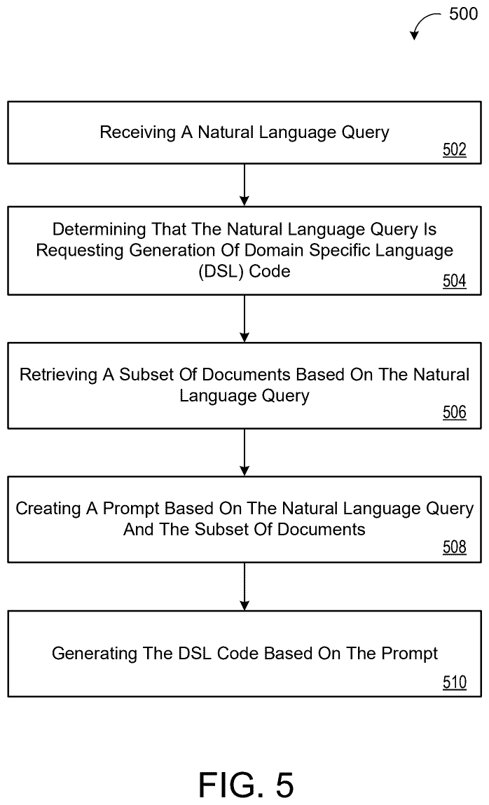

FIG. 5 is a flowchart of an exemplary arrangement of operations for a computer-implemented method 500 of generating DSL code 172. At operation 502, the method 500 includes receiving a natural language query 102. At operation 504, the method 500 includes determining that the natural language query 102 is requesting generation of DSL code 172. Based on determining that the natural language query 102 is requesting generation of DSL code 172, the method 500, at operation 506, includes retrieving a subset of documents 200S based on the natural language query 102 from a search index 440 including a set of documents 200. Advantageously, by retrieving only the subset of documents 200S, the method 500 focuses the LLM 170 on the relevant information only for the natural language query 102. At operation 508, the method 500 includes generating (i.e., creating) a prompt 162 based on the natural language query 102 and the subset of documents 200S. The prompt 162, when processed by the LLM 170, causes the LLM 170 to generate DSL code 172 that is relevant and accurate for the natural language query 102 despite the LLM 170 not being trained on the DSL code 172. At operation 510, the method 500 includes generating the DSL code 172 based on the prompt 162 using the LLM 170.

Thus, the code generator 105 enables efficient and scalable generation of DSL code 172 using the LLM 170 the need for fine-tuning on DSL examples. In fact, the LLM 170 may have never seen any DSL code 172 at all before receiving the natural language query 102. To address the lack of training, the code generator 105 uses the search index 440 to inform the LLM 170, via prompting, how to generate the DSL code 172. Notably, the code generator 105 only provides the LLM 170 with portions of the DSL specification 202P that are relevant to the natural language query 102 so as to not overwhelm the LLM 170 or exceed the input token limit of the LLM 170. LLMs 170 may be overwhelmed by long prompts such that even though information is included in a prompt, the LLM 170 ignores the information due to the prompt being excessively long. Thus, providing the LLM 170 with the subset of documents 200S focuses the LLM 170 on the relevant information for the natural language query 102.

Moreover, the code generator 105 is scalable for multiple different DSLs. That is, to integrate a new DSL, the code generator 105 only needs to generate the search index 440 for the new DSL rather than training or fine-tuning the LLM 170 on the new DSL. Generating the search index 440 for the new DSL is much more computationally efficient than training or fine-tuning the LLM 170 on the new DSL.

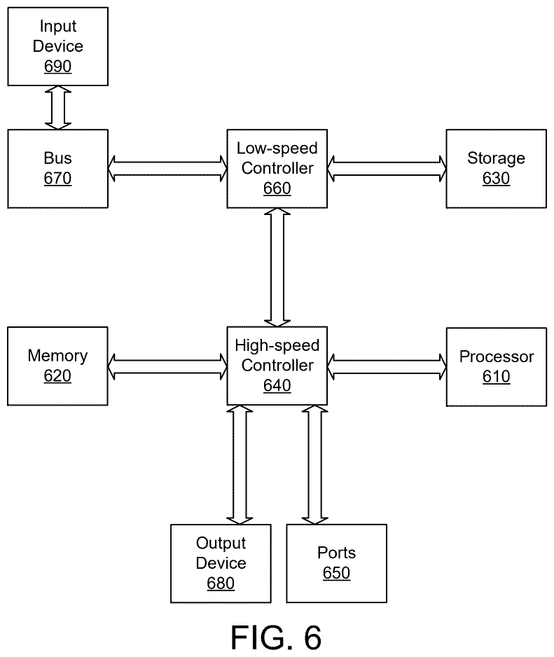

FIG. 6 is a schematic view of an example computing device 600 that may be used to implement the systems and methods described in this document. The computing device 600 is intended to represent various forms of digital computers, such as laptops, desktops, workstations, tablets, smartphones, servers, blade servers, mainframes, and other appropriate computers. The components shown here, their connections and relationships, and their functions, are meant to be illustrative only, and are not meant to limit implementations described and/or claimed in this document.

The computing device 600 includes a processor 610, memory 620, a storage device 630, a high-speed interface/controller 640 connecting to the memory 620 and high-speed expansion ports 650, and a low-speed interface/controller 660 connecting to a low-speed bus 670 and a storage device 630. Each of the components 610, 620, 630, 640, 650, and 660, are interconnected using various busses, and may be mounted on a common motherboard or in other manners as appropriate. The processor 610 can execute instructions for performing operations within the computing device 600, including instructions stored in the memory 620 or on the storage device 630 to display graphical information for a graphical user interface (GUI) on an external input/output device, such as display 680 coupled to high-speed interface 640. In other implementations, multiple processors and/or multiple buses may be used, as appropriate, along with multiple memories and types of memory. Also, multiple computing devices 600 may be connected, with each device providing portions of the necessary operations (e.g., as a server cluster, a group of blade servers, or a multi-processor system).

The memory 620 stores information within the computing device 600. The memory 620 may be a non-transitory computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 630 is capable of providing mass storage for the computing device 600. In some implementations, the storage device 630 is a non-transitory computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is embodied in a non-transitory information carrier. The computer program product contains instructions that, when executed, perform one or more methods, such as those described above. The information carrier is a non-transitory computer-readable medium, such as the memory 620, the storage device 630, or memory on processor 610.

The high-speed controller 640 manages bandwidth-intensive operations for the computing device 600, while the low-speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port or input device 690. The low-speed expansion port 690, which may include various communication ports (e.g., USB, Bluetooth, Ethernet, wireless Ethernet), may be coupled to one or more input/output devices, such as a keyboard, a pointing device, a microphone, a touch screen, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the term “non-transitory computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory computer-readable medium that receives machine instructions as a non-transitory computer-readable signal. The term “non-transitory computer-readable signal” refers to any signal used to provide machine instructions and/or data to a programmable processor.

A software application (i.e., a software resource) may refer to computer software that instructs a computing device to perform a specific function or set of functions. A software application may be executed by a processor, a virtual machine, a web browser, or another software component on the computing device. In some examples, a software application may be referred to as an “application,” an “app,” a “program,” or a “service.” Example applications include, but are not limited to, system diagnostic applications, system management applications, system maintenance applications, word processing applications, spreadsheet applications, messaging applications, media streaming applications, social networking applications, gaming applications, e-commerce applications, cloud computing applications, artificial intelligence applications, and blockchain applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a non-volatile memory or a volatile memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Non-transitory computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more implementations of the disclosure can be implemented on a computer having a display device, e.g., a LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
receiving a natural language query;
determining that the natural language query is requesting generation of domain specific language (DSL) code;
based on determining that the natural language query is requesting generation of DSL code, retrieving, from a search index comprising a set of documents, a subset of documents based on the natural language query, each document of the set of documents comprising a respective portion of a DSL specification paired with a respective natural language context;
generating a prompt based on the natural language query and the subset of documents; and
generating, using a large language model (LLM), the DSL code based on the prompt.

2. The method of claim 1, wherein the respective natural language context explains a relationship between the respective portion of the DSL specification and other respective portions of the DSL specification.

3. The method of claim 1, wherein the respective natural language context describes application programming interface (API) steps of the respective portion of the DSL specification.

4. The method of claim 1, wherein the DSL specification defines syntax, semantics, and structure for a plurality of application programming interfaces (APIs) of the DSL.

5. The method of claim 1, wherein the DSL specification comprises example DSL code snippets and comments associated with the example DSL code.

6. The method of claim 1, further comprising, for each document in the set of documents:
generating a contextual prompt based on the DSL specification and the respective portion of the DSL specification;
generating, using the LLM, the respective natural language context based on the contextual prompt; and
storing the respective portion of the DSL specification paired with the respective natural language context in the search index.

7. The method of claim 6, further comprising, for each document in the set of documents:
generating a respective searchable embedding based on the respective portion of the DSL specification paired with the respective natural language context; and
storing the respective searchable embedding in the search index.

8. The method of claim 7, further comprising, for each document of the set of documents, determining a relevancy score based on the natural language query and the respective searchable embedding.

9. The method of claim 8, further comprising, for each document in the subset of documents, determining that the relevancy score satisfies a relevancy threshold.

10. The method of claim 1, further comprising, for each document of the set of documents, determining a relevancy score based on the natural language query and the respective natural language context.

11. The method of claim 1, further comprising:
determining that the DSL code satisfies a diagnostic threshold; and
based on determining that the DSL code satisfies the diagnostic threshold, deploying the DSL code.

12. The method of claim 1, further comprising:
determining that the DSL code comprises a dynamic parameter;
retrieving, from a database, a value for the dynamic parameter; and
modifying the DSL code based on the value for the dynamic parameter.

13. The method of claim 1, wherein the LLM is trained on training data that does not include any DSL code examples.

14. A system comprising:
data processing hardware; and
memory hardware in communication with the data processing hardware, the memory hardware storing instructions that when executed on the data processing hardware cause the data processing hardware to perform operations comprising:
receiving a natural language query;
determining that the natural language query is requesting generation of domain specific language (DSL) code;
based on determining that the natural language query is requesting generation of DSL code, retrieving, from a search index comprising a set of documents, a subset of documents based on the natural language query, each document of the set of documents comprising a respective portion of a DSL specification paired with a respective natural language context;
generating a prompt based on the natural language query and the subset of documents; and
generating, using a large language model (LLM), the DSL code based on the prompt.

15. The system of claim 14, wherein the operations further comprise, for each document in the set of documents:
generating a contextual prompt based on the DSL specification and the respective portion of the DSL specification;
generating, using the LLM, the respective natural language context based on the contextual prompt; and
storing the respective portion of the DSL specification paired with the respective natural language context in the search index.

16. The system of claim 15, wherein the operations further comprise, for each document in the set of documents:
generating a respective searchable embedding based on the respective portion of the DSL specification paired with the respective natural language context at the search index; and
storing the respective searchable embedding in the search index.

17. The system of claim 16, wherein the operations further comprise:
for each document of the set of documents, determining a relevancy score based on the natural language query and the respective searchable embedding; and
for each document in the subset of documents, determining that the relevancy score satisfies a relevancy threshold.

18. The system of claim 14, wherein the operations further comprise:
determining that the DSL code satisfies a diagnostic threshold; and
based on determining that the DSL code satisfies the diagnostic threshold, deploying the DSL code.

19. The system of claim 14, wherein the operations further comprise:
determining that the DSL code comprises a dynamic parameter;
retrieving, from a database, a value for the dynamic parameter; and
modifying the DSL code based on the value for the dynamic parameter.

20. A computer-readable medium having instructions that, when executed by data processing hardware, causes the data processing hardware to perform operations comprising:
receiving a natural language query;
determining that the natural language query is requesting generation of domain specific language (DSL) code;
based on determining that the natural language query is requesting generation of DSL code, retrieving, from a search index comprising a set of documents, a subset of documents based on the natural language query, each document of the set of documents comprising a respective portion of a DSL specification paired with a respective natural language context;
generating a prompt based on the natural language query and the subset of documents; and
generating, using a large language model (LLM), the DSL code based on the prompt.
